(19) United States
(12) Patent Application Publication
(10) Pub. No.: US 2026/0334379 A1
(43) Pub. Date: Oct. 29, 2026

(54) DOUBLE-LAYER PLANTING BOX STRUCTURE AND A PREPARATION METHOD THEREOF

(71) Applicant: NINGBO ANSOL CABINET CO., LTD., Ningbo (CN)

(72) Inventor: Limin Yuan, Ningbo (CN)

(21) Appl. No.: 19/631,123

(22) Filed: Mar. 27, 2026

(30) Foreign Application Priority Data
Apr. 28, 2025 (CN) 202510548916.9

(51) Int. Cl. A01G 9/02; A01G 29/00; B29D 22/00

(52) U.S. Cl. CPC A01G 9/021; A01G 29/00; B29D 22/003

(57) ABSTRACT

A double-layer planting box structure and a preparation method thereof, relating to the technical field of horticultural supplies; the planting box comprises a planting box main body, wherein the planting box main body includes an inner side wall, an outer side wall, and a closed water storage cavity enclosed thereby; the inner side wall is distributed with small holes capable of generating capillary action, utilizing capillary action to uniformly moisten soil placed in planting box, and speed and degree of soil moistening can be controlled by adjusting size, position, and number of capillary seepage holes; sealed design of the water storage cavity enables nearly zero loss of stored water and water-soluble fertilizers; it can solve problems of traditional planting pots such as frequent watering, bottom leakage affecting sanitation and fertilizer efficiency loss, soil compaction, uneven humidity, and large temperature differences between day and night.

### TECHNICAL FIELD

The invention relates to the technical field of horticultural supplies, specifically to a double-layer planting box structure and a preparation method thereof.

### BACKGROUND ART

Plant pots are basin-shaped utensils used in landscaping engineering projects, primarily in private gardens, villas, and residential greening areas. Currently, planting pots available on the market, such as flower pots, fruit and vegetable pots, and landscape pots, are all single-walled pots with a separate water tray placed at bottom to prevent water from seeping out and soiling the ground. However, such traditional planting pots have the following serious defects:
1. Excess water from traditional planting pots leaks out from the bottom, while the surrounding soil near the pot walls is exposed to light, resulting in high temperatures and significant water evaporation. Frequent watering adversely affects the respiration of plant roots and hinders plant growth.
2. Residual water from watering often carries dirt and soil particles, which leak out and accumulate in the water tray. This not only affects aesthetics but also promotes the breeding of bacteria and mosquitoes, creating additional maintenance troubles.
3. During watering, a large amount of water carries fertilizers from the soil, which seep to the bottom of the planting pot or leak out, resulting in significant loss of fertilizer efficiency.
4. In traditional planting pots, watering often leads to water accumulation on the surface, which flows rapidly through large gaps in the soil. This not only causes surface soil compaction, affecting plant respiration, but also results in uneven soil moisture, as the middle and lower layers of soil may not absorb enough water before the excess drains away.

### SUMMARY OF THE INVENTION

To achieve the above objectives, the invention provides the following technical solution: a double-layer planting box structure and a preparation method thereof comprise a planting box main body; the planting box main body includes an inner side wall, an outer side wall, and a water storage cavity disposed between the inner side wall and the outer side wall; the inner side wall is provided with a plurality of capillary seepage holes.

As a preferred technical solution of the invention, the plurality of capillary seepage holes are distributed on bottom surface and side walls of the inner side wall.

As a preferred technical solution of the invention, bottoms of the inner side wall and the outer side wall are correspondingly provided with a plurality of intersecting wall reinforcing ribs, the wall reinforcing ribs are segmented and arched toward the water storage cavity for deepening.

As a preferred technical solution of the invention, intersection points of two adjacent segments of the wall reinforcing ribs are the deepest depressions, the intersection points of the wall reinforcing ribs on the inner side wall and the outer side wall correspond to each other and are interconnected to form bottom inner and outer wall support points.

As a preferred technical solution of the invention, a top of the outer side wall is provided with a peripheral handhold step, with all four sides of the handhold step being arc-shaped.

As a preferred technical solution of the invention, four corners of the handhold step are each provided with a connecting hole for connecting two or more planting box main bodies, fixing a plant climbing frame, or facilitating the fixation of the planting box main body on a three-dimensional planting rack.

As a preferred technical solution of the invention, tops of the inner side wall and the outer side wall collectively form a peripheral groove, and the groove is provided with water injection holes that communicate with an interior of the water storage cavity.

As a specific technical solution of this embodiment, a side wall of the inner side wall is provided with a plurality of side wall reinforcing ribs, a drainage hole is further provided between the inner side wall and the outer side wall, which does not communicate with the interior of the water storage cavity, a hole plug is movably inserted into a bottom of the drainage hole.

A preparation method for a double-layer planting box structure comprises the following steps:
S1: forming a double-layer hollow structure: the inner side wall, the outer side wall, and the water storage cavity therebetween are integrally formed using a plastic blow molding process; alternatively, the inner side wall and the outer side wall are manufactured separately and then assembled into a closed double-layer hollow structure through a splicing process;
S2: processing capillary seepage micro-holes: laser cutting or hot-melt perforation is used to process capillary seepage holes, i.e., small holes capable of generating capillary action, on bottom surface and side wall seepage areas of the inner side wall;
S3: providing water injection holes: water injection holes are opened in the top groove of the planting box main body or on the outer side wall;
S4: reinforcing the box structure: during injection molding, a handhold step with arc-shaped concave sides is formed on the top of the outer side wall; side wall reinforcing ribs are provided on the inner side wall, a plurality of intersecting arched wall reinforcing ribs, deepened toward the cavity, are formed on bottom surfaces of the inner side wall and the outer side wall;
S5: providing multifunctional connecting holes: connecting holes are provided at four inner corners of the handhold step for connecting two or more planting box main bodies, fixing a plant climbing frame, or facilitating the fixation of the planting box main body on a three-dimensional planting rack;
S6: providing a drainage hole: the drainage hole that does not communicate with the interior of the water storage cavity is provided between the inner side wall and the outer side wall to prevent water accumulation inside the planting box main body in outdoor rainy environments; wherein a hole plug is provided for sealing the drainage hole when the planting box is not placed outdoors.

As a specific technical solution of this embodiment, in S1, an electric heating device is optionally arranged inside the water storage cavity to control water temperature when heating is required; in S3, a water pipe interface is optionally configured at an outer end of the water injection hole to connect to an external water supply device when automatic water replenishment is needed.

Compared with the prior art, the invention provides a double-layer planting box structure and a preparation method thereof, with the following beneficial effects:
the double-layer planting box structure and its preparation method, through the double-walled water storage cavity and capillary seepage holes, utilize capillary action to slowly and uniformly moisten the soil, solving the problems of frequent watering, soil compaction, and uneven humidity caused by gravity drainage in traditional planting pots. The sealed design of the water storage cavity ensures near-zero loss of water and fertilizer, reducing fertilizer waste and avoiding the breeding of bacteria and mosquitoes in the water tray. The wall reinforcing ribs and the bottom inner and outer wall support points enhance load-bearing capacity, accommodating thick soil layers and large plant cultivation needs. Modular connecting holes support expansion stacking or climbing frame fixation, improving usage flexibility. The integration of water pipes and electric heating devices in the water storage cavity enables automatic water replenishment and temperature regulation, making it suitable for extreme environments such as deserts and cold regions. This provides a low-cost, high-efficiency solution for modern planting, offering broad application prospects.

### BRIEF DESCRIPTION OF ACCOMPANY DRAWINGS

FIG. 1 is a structural diagram of a double-layer planting box structure and a preparation method thereof according to the invention.

FIG. 2 is a cross-sectional structural diagram of a double-layer planting box structure and a preparation method thereof according to the invention.

FIG. 3 is a cross-sectional structural diagram of a handhold step of a double-layer planting box structure and a preparation method thereof according to the invention.

FIG. 4 is a cross-sectional structural diagram of side wall reinforcing ribs of a double-layer planting box structure and a preparation method thereof according to the invention.

FIG. 5 is a side view of a planting box main body of a double-layer planting box structure and a preparation method thereof according to the invention.

FIG. 6 is a schematic diagram of the connection and combination of two planting box main bodies of a double-layer planting box structure and a preparation method thereof according to the invention.

FIG. 7 is a schematic structural diagram of an electric heating device of a double-layer planting box structure and a preparation method thereof according to the invention.

FIG. 8 is a diagram of a preparation method of a double-layer planting box structure and a preparation method thereof according to the invention.

FIG. 9 is a cross-sectional structural diagram of a drainage hole of a double-layer planting box structure and a preparation method thereof according to the invention.

In the drawings: 1. planting box main body; 11. inner side wall; 12. outer side wall; 13. water storage cavity; 14. capillary seepage hole; 15. wall reinforcing rib; 16. bottom inner and outer wall support point; 17. handhold step; 171. connecting hole; 18. groove; 181. water injection hole; 19. side wall reinforcing rib; 2. electric heating device; 3. drainage hole; 31. hole plug.

### SPECIFIC EMBODIMENT OF THE INVENTION

The technical solutions of the embodiments of the invention will be clearly and completely described below with reference to the accompanying drawings. Obviously, the described embodiments are only a part of the embodiments of the invention, not all of them. Based on the embodiments of the invention, all other embodiments obtained by ordinary skilled personnel in the art without creative efforts shall fall within the scope of protection of the invention.

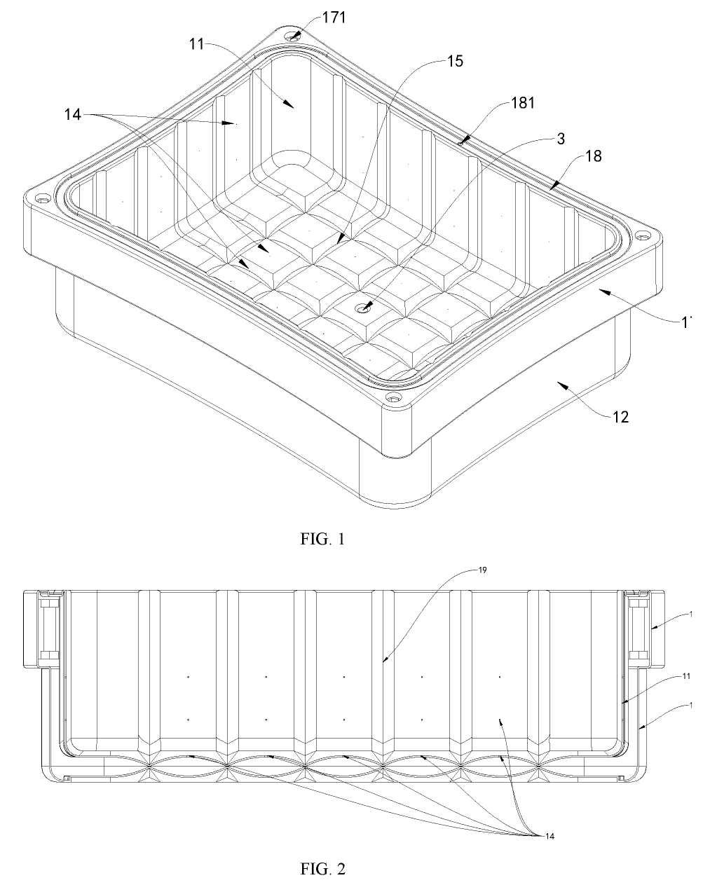

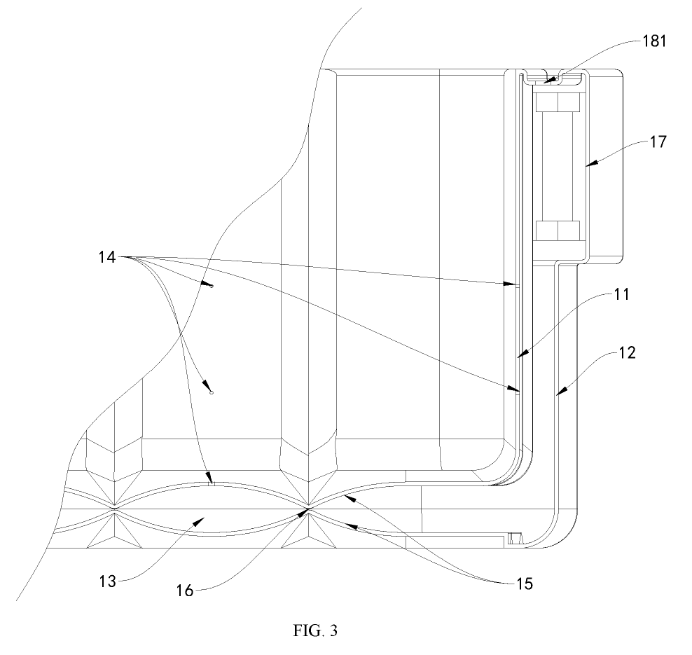

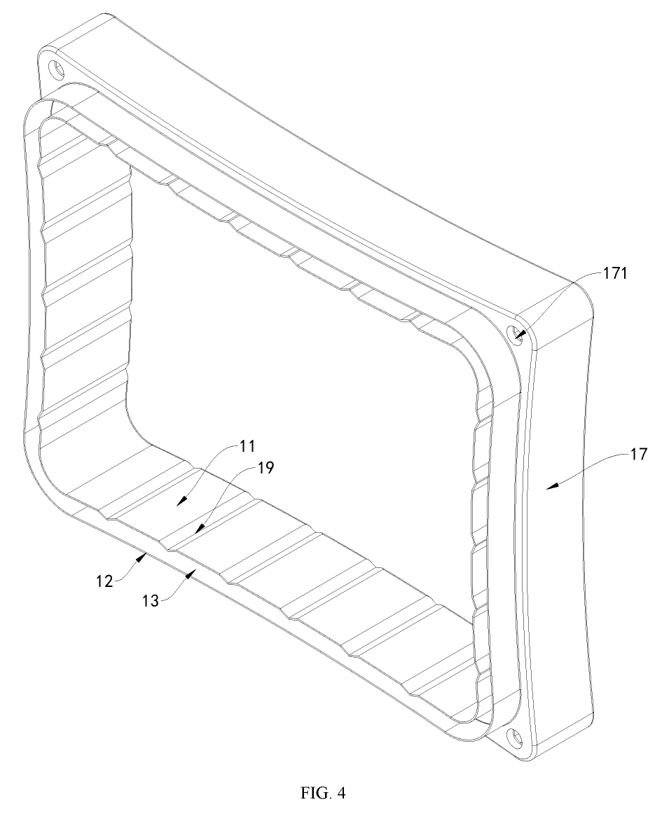

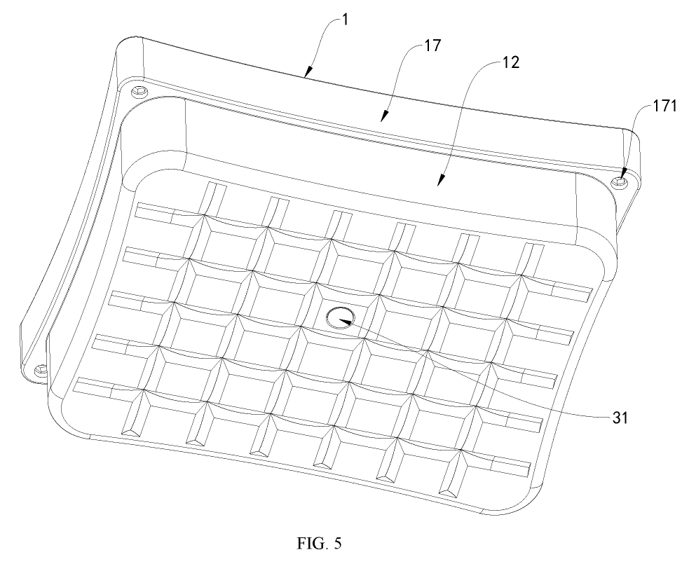

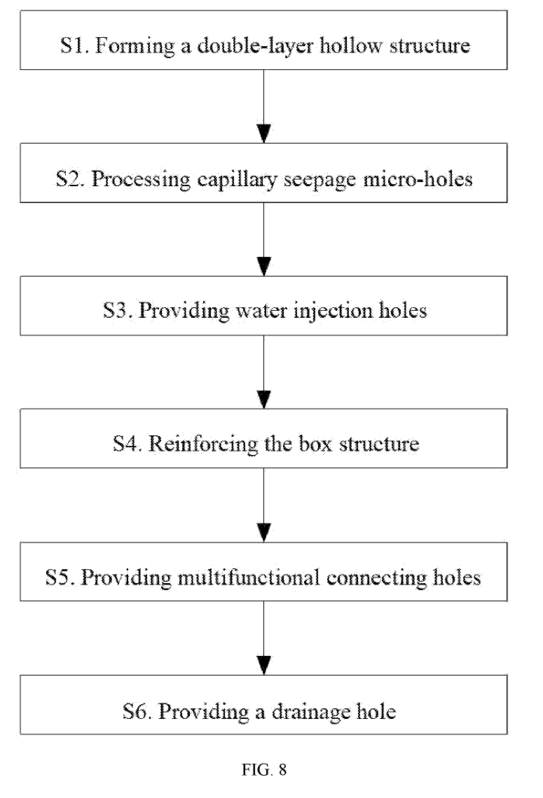

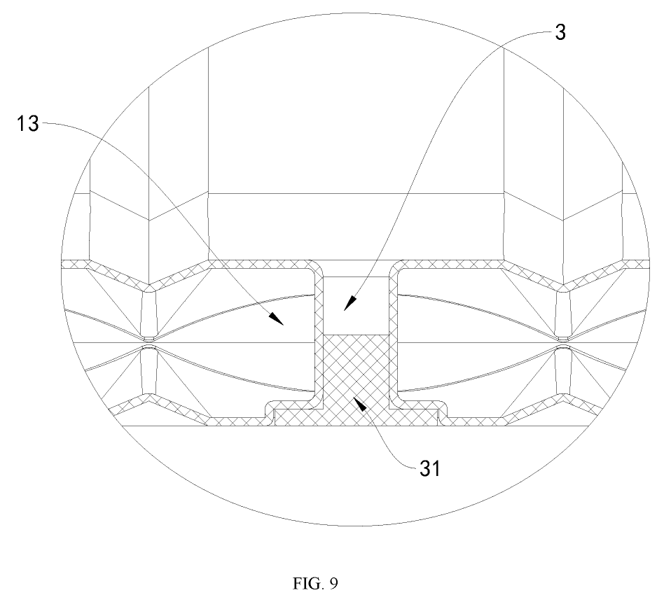

Please refer to FIGS. 1-9. A double-layer planting box structure and a preparation method thereof comprise a planting box main body 1; the planting box main body 1 includes an inner side wall 11, an outer side wall 12, and a water storage cavity 13 disposed between the inner side wall 11 and the outer side wall 12; the inner side wall 11 is provided with a plurality of capillary seepage holes 14.

As a specific technical solution of this embodiment, the plurality of capillary seepage holes 14 are distributed on bottom surface and side walls of the inner side wall 11, and a diameter of each capillary seepage hole 14 is less than 0.3 mm.

In this embodiment, by limiting the diameter of the capillary seepage holes 14 to less than 0.3 mm (e.g., 0.1 mm to 0.25 mm), capillary action is utilized to allow water in the water storage cavity 13 to slowly and uniformly seep into the soil, avoiding the rapid drainage of water and loss of fertilizer caused by gravity in traditional planting pots. Additionally, the distribution of holes on the bottom surface and side walls of the inner side wall 11 ensures that water infiltrates the soil from multiple directions, solving the problem of "surface water accumulation and compaction, uneven moisture absorption in lower layers" in traditional pots.

As a specific technical solution of this embodiment, bottoms of the inner side wall 11 and the outer side wall 12 are correspondingly provided with a plurality of intersecting wall reinforcing ribs 15, the wall reinforcing ribs 15 are segmented and arched toward the water storage cavity 13 for deepening.

In this embodiment, the intersecting arched wall reinforcing ribs 15 significantly enhance the load-bearing capacity of the double-layer wall, preventing deformation or collapse of the inner and outer walls caused by soil weight pressure. This is particularly suitable for planting large plants or using thick soil layers. The arched design disperses the pressure borne by the inner side wall 11 to the outer side wall 12 and its support points, extending the service life of the planting box main body 1.

As a specific technical solution of this embodiment, intersection points of two adjacent segments of the wall reinforcing ribs 15 are the deepest depressions. The intersection points of the wall reinforcing ribs 15 on the inner side wall 11 and the outer side wall 12 correspond to each other and are interconnected to form bottom inner and outer wall support points 16.

In this embodiment, the interconnection design of the bottom inner and outer wall support points 16 at the intersection points of the wall reinforcing ribs 15 on the inner side wall 11 and the outer side wall 12 forms a three-dimensional mesh support structure, enhancing the compressive resistance of the double-layer wall bottom and preventing leakage caused by long-term pressure on the water storage cavity 13. Additionally, the bottom inner and outer wall support points 16 limit relative displacement between the inner side wall 11 and the outer side wall 12, ensuring the stability of the capillary seepage holes 14 and maintaining uniform water seepage.

As a specific technical solution of this embodiment, a top of the outer side wall 12 is provided with a peripheral handhold step 17, with all four sides of the handhold step 17 being arc-shaped.

In this embodiment, the arc-shaped concave handhold step 17 on the top of the outer side wall 12 provides an ergonomic grip for easy transportation of the planting box main body 1. The arc-shaped concave design on all four sides prevents hand injuries during handling and adapts to narrow spaces, such as when retrieving the box placed against a wall.

As a specific technical solution of this embodiment, four corners of the handhold step 17 are each provided with a connecting hole 171 for connecting two or more planting box main bodies 1, fixing a plant climbing frame, or facilitating the fixation of the planting box main body 1 on a three-dimensional planting rack.

In this embodiment, the four corner connecting holes 171 support modular expansion:

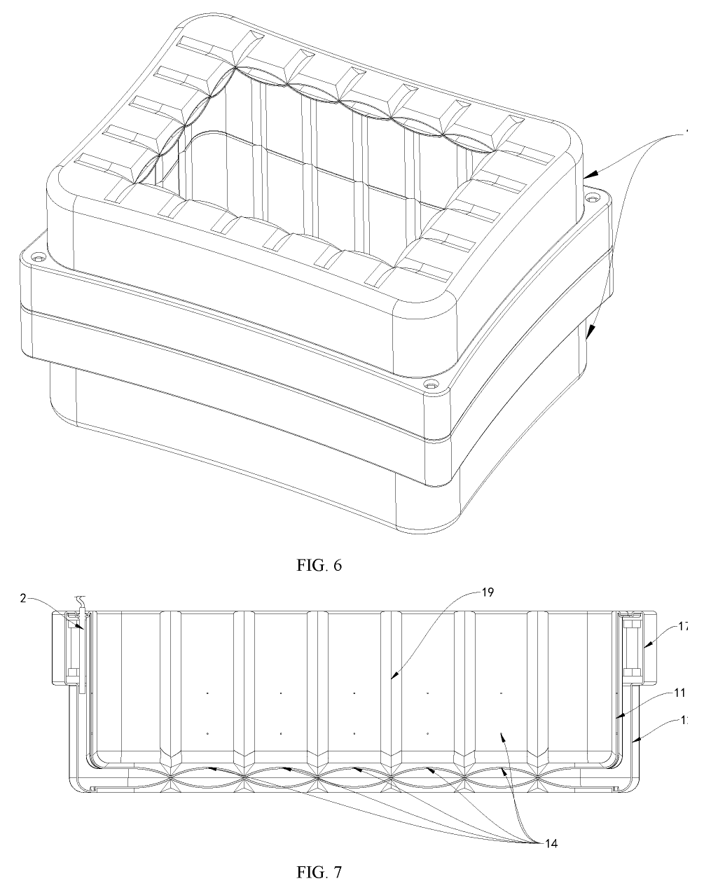

Stacking connection: referring to FIG. 6, two planting box main bodies 1 are stacked vertically, the upper planting box main body 1 is provided with through holes to increase soil layer thickness, facilitating the planting of deep-rooted plants; screws are used to fix two planting box main bodies 1 through the connecting holes 171. Water flows into the upper planting box main body 1 through a periphery of the through holes, and water inside the upper planting box main body 1 can flow into the water storage cavity 13 of the lower planting box main body 1 through a groove 18 and water injection holes 181. After screwing the two planting box main bodies 1 together, a seal is maintained between them.

Climbing frame fixation: plant climbing frames can be inserted through the connecting holes 171 for planting twining or climbing plants, avoiding the inconvenience of additional drilling required in traditional pots.

Quick assembly and disassembly: the screw connection facilitates layout adjustment or disassembly for cleaning.

As a specific technical solution of this embodiment, tops of the inner side wall 11 and the outer side wall 12 collectively form a peripheral groove 18, and the groove 18 is provided with water injection holes 181 that communicate with an interior of the water storage cavity 13.

In this embodiment, the integrated design of the top groove 18 and the water injection holes 181 enables convenient water injection, the water injection holes 181 are directly connected to the water storage cavity 13, avoiding the trouble of frequently emptying a water tray in traditional pots. The groove 18 can also collect rainwater or irrigation excess, returning it to the water storage cavity 13 through the water injection holes 181, improving water resource utilization.

As a specific technical solution of this embodiment, a side wall of the inner side wall 11 is provided with a plurality of side wall reinforcing ribs 19, a drainage hole 3 is further provided between the inner side wall 11 and the outer side wall 12, which does not communicate with the interior of the water storage cavity 13, a hole plug 31 is movably inserted into a bottom of the drainage hole 3.

In this embodiment, the side wall reinforcing ribs 19 enhance the lateral compression resistance of the inner side wall 11, preventing wall cracking caused by soil expansion or root growth. They also assist in positioning the capillary seepage holes 14, avoiding blockage of seepage channels due to wall deformation.

A preparation method for a double-layer planting box structure comprises the following steps:
S1: forming a double-layer hollow structure: the inner side wall 11, the outer side wall 12, and the water storage cavity 13 therebetween are integrally formed using a plastic blow molding process; alternatively, the inner side wall 11 and the outer side wall 12 are manufactured separately and then assembled into a closed double-layer hollow structure through a splicing process;
S2: processing capillary seepage micro-holes: laser cutting or hot-melt perforation is used to process capillary seepage holes 14, i.e., small holes capable of generating capillary action, on bottom surface and side wall seepage areas of the inner side wall 11;
S3: providing water injection holes: water injection holes 181 are opened in the top groove 18 of the planting box main body 1 or on the outer side wall;
S4: reinforcing the box structure: during injection molding, a handhold step 17 with arc-shaped concave sides is formed on the top of the outer side wall 12; side wall reinforcing ribs 19 are provided on the inner side wall 11, a plurality of intersecting arched wall reinforcing ribs 15, deepened toward the cavity, are formed on bottom surfaces of the inner side wall 11 and the outer side wall 12;
S5: providing multifunctional connecting holes: connecting holes 171 are provided at four inner corners of the handhold step 17 for connecting two or more planting box main bodies 1, fixing a plant climbing frame, or facilitating the fixation of the planting box main body 1 on a three-dimensional planting rack;
S6: providing a drainage hole: the drainage hole 3 that does not communicate with the interior of the water storage cavity 13 is provided between the inner side wall 11 and the outer side wall 12 to prevent water accumulation inside the planting box main body 1 in outdoor rainy environments; wherein a hole plug 31 is provided for sealing the drainage hole 3 when the planting box is not placed outdoors.

The planting box main body 1 is preferably formed using a blow molding process. The integral blow molding process ensures that the water storage cavity 13 between the inner and outer walls is completely sealed without splicing gaps. Additionally, the blow molding air inlet can be directly used as the water injection hole 181, simplifying the production process and reducing costs.

As a specific technical solution of this embodiment, in S1, an electric heating device 2 is optionally arranged inside the water storage cavity 13 to control water temperature when heating is required. In S3, a water pipe interface is optionally configured at an outer end of the water injection hole 181 to connect to an external water supply device when automatic water replenishment is needed.

In this embodiment, referring to FIG. 7, an electric heating device 2 is built into the water storage cavity 13. The electric heating device 2 uses heating wires or tubes; a power connection end of the electric heating device 2 is connected to a temperature controller via wires exiting from the water injection port or groove. Soil temperature is regulated by adjusting the water temperature, adapting to the growth needs of plants in cold regions or tropical areas. A water level sensor is installed inside the water storage cavity 13, and the water injection hole 181 is externally connected to a water pipe for automatic water replenishment, achieving the effect of "no manual watering, constant temperature and humidity."

In summary, the double-layer planting box structure and its preparation method, through the double-walled water storage cavity 13 and capillary seepage holes 14, utilize capillary action to slowly and uniformly moisten the soil, solving the problems of frequent watering, soil compaction, and uneven humidity caused by gravity drainage in traditional planting pots. The sealed design of the water storage cavity 13 ensures near-zero loss of water and fertilizer, reducing fertilizer waste and avoiding the breeding of bacteria and mosquitoes in the water tray. The wall reinforcing ribs 15 and the bottom inner and outer wall support points 16 enhance load-bearing capacity, accommodating thick soil layers and large plant cultivation needs. Modular connecting holes 171 support expansion stacking or climbing frame fixation, improving usage flexibility. The integration of water pipes and electric heating devices 2 in the water storage cavity 13 enables automatic water replenishment and temperature regulation, making it suitable for extreme environments such as deserts and cold regions. This provides a low-cost, high-efficiency solution for modern planting, offering broad application prospects.

It should be noted that terms such as "include," "comprise," or any other variations thereof are intended to cover non-exclusive inclusion, so that a process, method, article, or device that includes a series of elements includes not only those elements but also other elements not explicitly listed, or elements inherent to such process, method, article, or device. In the absence of further restrictions, an element defined by the phrase "including a ..." does not exclude the presence of additional identical elements in the process, method, article, or device that includes the element.

Although the embodiments of the invention have been shown and described, it will be understood by those of ordinary skill in the art that various changes, modifications, substitutions, and variations can be made to these embodiments without departing from the principles and spirit of the invention. The scope of the invention is defined by the appended claims and their equivalents.

1. A double-layer planting box structure, comprising a planting box main body; the planting box main body includes an inner side wall, an outer side wall, and a water storage cavity disposed between the inner side wall and the outer side wall; the inner side wall is provided with a plurality of capillary seepage holes.

2. The double-layer planting box structure of claim 1, wherein the plurality of capillary seepage holes are distributed on bottom surface and side walls of the inner side wall.

3. The double-layer planting box structure of claim 1, wherein bottoms of the inner side wall and the outer side wall are correspondingly provided with a plurality of intersecting wall reinforcing ribs, the wall reinforcing ribs are segmented and arched toward the water storage cavity for deepening.

4. The double-layer planting box structure of claim 3, wherein intersection points of two adjacent segments of the wall reinforcing ribs are the deepest depressions, the intersection points of the wall reinforcing ribs on the inner side wall and the outer side wall correspond to each other and are interconnected to form bottom inner and outer wall support points.

5. The double-layer planting box structure of claim 1, wherein a top of the outer side wall is provided with a peripheral handhold step, with all four sides of the handhold step being arc-shaped.

6. The double-layer planting box structure of claim 5, wherein four corners of the handhold step are each provided with a connecting hole for connecting two or more planting box main bodies, fixing a plant climbing frame, or facilitating the fixation of the planting box main body on a three-dimensional planting rack.

7. The double-layer planting box structure of claim 1, wherein tops of the inner side wall and the outer side wall collectively form a peripheral groove, and the groove is provided with water injection holes that communicate with an interior of the water storage cavity.

8. The double-layer planting box structure of claim 1, wherein a side wall of the inner side wall is provided with a plurality of side wall reinforcing ribs, a drainage hole is further provided between the inner side wall and the outer side wall, which does not communicate with the interior of the water storage cavity, a hole plug is movably inserted into a bottom of the drainage hole.

9. A preparation method for a double-layer planting box structure of claim 1 comprising the following steps:
S1: forming a double-layer hollow structure: the inner side wall, the outer side wall, and the water storage cavity there between are integrally formed using a plastic blow molding process; alternatively, the inner side wall and the outer side wall are manufactured separately and then assembled into a closed double-layer hollow structure through a splicing process;
S2: processing capillary seepage micro-holes: laser cutting or hot-melt perforation is used to process capillary seepage holes, i.e., small holes capable of generating capillary action, on bottom surface and side wall seepage areas of the inner side wall;
S3: providing water injection holes: water injection holes are opened in the top groove of the planting box main body or on the outer side wall;
S4: reinforcing the box structure: during injection molding, a handhold step with arc-shaped concave sides is formed on the top of the outer side wall; side wall reinforcing ribs are provided on the inner side wall, a plurality of intersecting arched wall reinforcing ribs, deepened toward the cavity, are formed on bottom surfaces of the inner side wall and the outer side wall;
S5: providing multifunctional connecting holes: connecting holes are provided at four inner corners of the handhold step for connecting two or more planting box main bodies, fixing a plant climbing frame, or facilitating the fixation of the planting box main body on a three-dimensional planting rack;
S6: providing a drainage hole: the drainage hole that does not communicate with the interior of the water storage cavity is provided between the inner side wall and the outer side wall to prevent water accumulation inside the planting box main body in outdoor rainy environments, wherein a hole plug is provided for sealing the drainage hole when the planting box is not placed outdoors.

10. The preparation method for a double-layer planting box structure of claim 9, wherein in S1, an electric heating device is optionally arranged inside the water storage cavity to control water temperature when heating is required; in S3, a water pipe interface is optionally configured at an outer end of the water injection hole to connect to an external water supply device when automatic water replenishment is needed.
